(19) United States
(12) Patent Application Publication
(10) Pub. No.: US 2007/0233390 A1
(43) Pub. Date: Oct. 4, 2007

(54) CURRENT GENERATION AND EARTHQUAKE PREDICTION

(76) Inventor: Friedemann T. Freund, Los Altos, CA (US)

Correspondence Address: Schneck & Schneck, P.O. Box 2-E, San Jose, CA, 95109-0005, US

(21) Appl. No.: 11/678,937

(22) Filed: Feb. 26, 2007

Related U.S. Application Data
(60) Provisional application No. 60/776,388, filed on Feb. 24, 2006.

(51) Int. Cl. G01V 1/00

(52) U.S. Cl. 702/15; 324/323

(57) ABSTRACT

A method for producing an electric current having a current value in a selected range at one end of a crystal or rock (“stone”), having a longitudinal axis and first and second ends of the stone along this axis. A stress is applied adjacent to the first end, to produce a non-uniform stress field in which the stress has a substantially different magnitude adjacent to the first end than a magnitude of the stress adjacent to the second end. An electric current, having a non-zero current value within a selected current value range is thereby generated, adjacent to at least one of the first end and the second end of the stone. The method is used to predict occurrence of an earthquake in a selected region of the Earth's surface, using presence of any of ten measurable conditions.

### FIELD OF THE INVENTION

This invention relates to the generation of electric currents in materials including naturally occurring rocks from the Earth's crust and to early warning signs associated with said currents and their side effects, indicative of impending major seismic activity.

### BACKGROUND OF THE INVENTION

Earthquake forecasting has been an elusive goal for a long time, not only for seismology. Yet, before a major earthquake, the Earth appears to sends out signals. Many of these signals point to transient electric currents in the Earth's crust. To search for the cause of such currents, attention has focused on piezoelectricity, a property of quartz and other material that produces a voltage difference when a material is squeezed substantially uniformly. No generally accepted, physics-based mechanism for the generation of large currents associated with earthquakes was available, and this has caused considerable confusion and controversy. Most geophysicists agree that earthquakes cannot be predicted as yet, although nearly every large event brings tales of animals sensing trouble hours or days beforehand and of people observing strange lights. No one knows what might cause such phenomena. Indeed, so many different mechanisms have been proposed as being behind the apparent warning signs of impending disaster that seismologists tend to view any claim with suspicion.

What is needed is a system and associated method for predicting occurrence of an earthquake from some simple physical measurements that precede such occurrence by a time interval of length a few seconds to several days, depending upon quake intensity and type of precursor signal. Preferably, the method should work with a few simple ground-based and/or airborne measuring devices, spaced apart over a region of interest, such as 1-400 square miles.

### SUMMARY OF THE INVENTION

These needs are met by the invention, which provides a method and system for measuring and analyzing changes in electric current associated with occurrence of non-homogeneous stress(es) in a ground material, such as crustal rocks, or a crystalline material, such as oxide or semiconductor materials (collectively referred to herein as “stone”). For the purpose of demonstrating the invention the stone is assumed to have a longitudinal axis, which is defined in part by the orientation of an imposed deviatoric stress field (not necessarily possessing any symmetry or uniformity). When a deviatoric stress field is applied to the stone, having a substantially different magnitude adjacent to a first end and a second end of the stone along the longitudinal axis, a voltage and associated electric current is generated having a non-zero voltage and associated non-zero current value, directed generally along the longitudinal axis. The current value will be time varying and will increase monotonically and saturate if the rate r of application of the deviatoric stress field is below a first threshold. If the rate r is above this first threshold, the current value will increase monotonically to a first (maximum) value, then decrease to a second saturation value.

When this current is generated in a stone, an associated magnetic field is generated adjacent to the stone, with a magnetic field intensity B(r;t) that is in part determined by the current value and is dependent upon time t and upon location vector r. The corresponding magnetic filed intensity B(r;t) can be distinguished from the background magnetic field intensity B(r;t;bg) adjacent to the Earth's surface, which has a magnitude of about 1.2 Gauss.

The deviatoric stress that generates this current may have been applied only at the first end of the stone and may comprise one or more of: compressive stress in a plane substantially transverse to the longitudinal axis; tension stress in a direction substantially transverse to the longitudinal axis; tension stress in a direction substantially parallel to the longitudinal axis; shear stress in a plane substantially transverse to the longitudinal axis; and shear stress in a plane having a plane component substantially parallel to the longitudinal axis.

The deviatoric stress that generates this current may have been applied only in a region between the first end and the second end of the stone, not including the first end and not including the second end of the stone, and may comprise one or more of: compressive stress in a plane substantially transverse to the longitudinal axis; tension stress in a direction substantially transverse to the longitudinal axis; tension stress in a direction substantially parallel to the longitudinal axis; shear stress in a plane substantially transverse to the longitudinal axis; and shear stress in a plane having a plane component substantially parallel to the longitudinal axis.

During rock deformation studies, it has been discovered that, when one squeezes a first end of a 1.2 meter length slab of granite (or slabs of quartz-free igneous rocks, such as anorthosite or gabbro, or high-grade metamorphic rocks), the stressed rock volume generates a voltage difference, which in turn causes two coupled outflow currents. A first current, carried by electrons, flows from the stressed rock directly to ground. A second current, carried by defect electrons or holes, flows into and through the unstressed rock and out a second end of the rock. These two currents are tightly coupled and often vary with time. The stressed rock behaves, in fact, as a battery. The amount of current flowing out of a stressed stone volume of one cubic kilometer can reach 10,000-100,000 Amp flowing for extended periods of time, at least hours to days. The discovery of this previously unknown capacity of igneous and high-grade metamorphic rocks to generate currents when subjected to deviatoric stresses provides a physical basis to re-evaluate a wide range of reported pre-earthquake signals as potential indicators of impending earthquake activity.

The current flowing from the stressed rock volume to ground through a metal contact or, more generally, n-type contact is carried by electrons. The current capable of flowing from the stressed rock into and through the surrounding unstressed rocks is carried by defect electrons in the oxygen anion sub-lattice, also known as positive holes, or p-holes for short. The stressed rock volume acts as a battery that is being charged by the action of the deviatoric stress. Extrapolating the laboratory data to geophysically relevant dimensions suggests that each cubic kilometer of stressed rock can generate currents on the order of 10,000-100,000 Amps flowing for days or weeks or months. The currents are not based on piezoelectricity, nor are they caused by any other process discussed in the literature thus far. These stress-activated currents in the Earth's crust may hold the key to decipher a wide range of electric, magnetic, electromagnetic and other signals or phenomena that have long been reported in connection with impending earthquake activity.

If the battery postulate is correct, the progressive build-up of deviatoric stresses in the ground prior to a major earthquake will activate large volumes of rock, hence, charge large batteries in the Earth's crust that can potentially generate enormous electrical currents in the ground together with a host of phenomena that are the consequences of the activation of electronic charge carriers in large rock volumes. Specifically and more to the point, some of these phenomena can be manifest themselves before a fault moves catastrophically, and thus provide some early warning of major seismic activity.

The recognition that squeezing crystals has electrical consequences is not new. Piezoelectrically, which is exploited in pressure sensors and quartz watches, involves creating a voltage between the ends of a piece of crystal, for instance quartz cut in a certain crystallographic direction, by applying pressure. In this situation, the voltage arises because the crystal deforms and the symmetry between positively and negatively charged atoms is disturbed.

A mechanism different from piezoelectricity has been explored, similar to one that occurs in a semiconductor and relying on charge separation. In many kinds of rock, most notably igneous and high-grade metamorphic rocks, the application of deviatoric stress and the resulting deformation of the rock's constituent crystals turn some of the oxygen anions into charge carriers. These oxygen anions, which occur as pairs forming peroxy links, are each missing an electron relative to the regular oxygen anions in the mineral matrix. They are referred to as “holes”. The holes are positively charged relative to the rest of the crystal structure. The effect of deviatoric stresses is to break the peroxy links and thereby create or activate the battery. One of the oxygen anions of the broken peroxy link can steal an electron from a neighboring oxygen anion, in effect shifting its hole to the neighboring anion's location. The electron coming in remains attached and weakly bound to the broken peroxy link. By exchanging electrons in this way other regular oxygen anions in the mineral matrix the holes can move through the rock, easily. As the holes move out of the stressed rock, they leave it behind with a surplus of electrons.

The weakly bound electrons in the stressed rock cannot follow the holes, because rocks are not good conductors of this more common form of electricity. The reason is that are essentially insulators and do not provide the necessary energy levels that electrons could use to pass through. What electrons require is a contact to an electron-conducting material that would allow them to flow out of the stressed rock volume. In a laboratory, this is easily done by attaching a metal contact to the stressed rock volume and a metal wire connected to another metal contact attached to the unstressed section of the rock. When the circuit is closed, the stressed rock volume acts as a battery allowing electrons to flow through the external wire and to meet the holes that flow through the rock.

Outside the laboratory, in nature, rock that is sufficiently hot to become conductive for electrons, above approximately 600° C., will be able to take on the role of the electron-conductive contact. For most of Earth's continental crust such hot rock is found along the geotherm at a depth range around 30±10 km.

Extrapolating from laboratory experiments, the stress along geological faults could, if the battery circuit closes, generate hundreds of thousands of amperes per cubic kilometer of stressed rock volume. The currents flow commonly in a fluctuating pattern that would cause low to extremely low frequency electromagnetic waves to be emitted.

Whether such currents and accompanying electromagnetic emissions can act as earthquake predictors depends on whether the changes in the stress level along a fault would cause major electric currents to flow before the fault slips. To date, no such electromagnetic emissions have been detected during the M=6 Parkfield earthquake of 2004 along the San Andreas Fault. The reason could be that either the volume of highly stressed rocks was too small or circuit closure never occurred before rupture or the battery currents were diverted through the brine-saturated gauge along the fault plane producing no detectable electromagnetic emission or change in the local magnetic field. No clearly identifiable ionospheric effects were observed either but changes in the humidity in the region around the epicenter were noted, indicative of a massive injection of airborne ions that served as condensation nuclei for water droplets, thereby lowering the water partial pressure in the atmosphere. Three kinds of pre-earthquake signals are documented by a large body of satellite data and/or ground-based data:

Low frequency electromagnetic emissions (EM),

Ionospheric perturbations,

Thermal infrared (TIR) anomalies.

All three types of pre-earthquake signals require either electric currents in the ground, often very powerful currents, or electrostatic charges on the surface of the Earth.

It has been difficult to understand how such currents may be generated deep in the Earth's crust and how a pervasive charge may form at the Earth's surface. Many different ideas and propositions have been circulated, mostly suggesting a different cause for each of the observed phenomena. However none of these ideas and propositions has found widespread acceptance in the scientific community. What is lacking is a comprehensive picture that would provide a physics-based explanation for most, if not all, pre-earthquake signals.

When subjected to non-uniform deviatoric stress, igneous and high-grade metamorphic rocks generate said battery currents. The currents carried by said p-holes propagate through more than 1 meter of dry granite in the laboratory and are expected to propagate likewise through kilometers of dense, dry or water-saturated rocks in the Earth's crust.

Traveling in the valence band of the constituent minerals the p-holes can jump from grain to grain and cross boundaries between different types of rock. They are not stopped by water films. The p-holes are long-distance runners. They can even pass from solid rocks to loosely consolidated sediments, gravel, sand and soil. They can become trapped at the surface and cause a positive surface charge. If this surface charge spreads laterally over an area of the Earth's surface that is a significant fraction of or larger than the distance between the surface of the Earth and the lower edge of the ionosphere, approximately 100 km, the surface charge will affect the position and composition of the ionospheric plasma, enabling energetic electrons to penetrate more deeply into the uppermost atmosphere, causing changes in the Total Electron Content (TOC) at satellite altitudes and electronic excitations of the atmospheric constituents in the uppermost atmosphere, in particular oxygen atoms, which then luminesce by emitting light at a wavelength of approximately 630 nanometer.

At the surface of the Earth, where the p-holes can become trapped, they build up microscopic electric fields that are high enough to cause field ionization of air molecules. This leads to injection of positive ions into the near-surface air. This can also lead to electric discharges into the air, which are luminous, and to the emission of broadband radio frequency noise.

The p-holes can recombine at the surface, returning to the paired state of peroxy bonds, in which they had existed before being activated by the action of deviatoric stresses at depth. The recombination is exothermic and leads to vibrationally highly excited oxygen-oxygen (peroxy) bonds, which can deactivate (i) radiatively by emitting infrared photons at the characteristics wavelength values corresponding to the energy differences between vibrationally excited states or (ii) non-radiatively by transferring energy to their neighboring atoms and ions in the mineral structure, which in turn become vibrationally excited and emit infrared photons at their characteristic wavelength values. This process corresponds to cold infrared luminescence and, as its final stage, to the thermalization of the energy released during recombination of p-holes, equivalent to an increase of radiative temperature of a thin surface layer.

A necessary and unavoidable effect of the activation of electronic charge carriers, the said weakly bound electrons and the said p-holes, in any volume of igneous and high-grade metamorphic rocks subjected to deviatoric stress is the increase of the number density of charge carriers in the said rock volume. With the increase of the number density of charge carriers comes an increase in the electrical conductivity of the rocks. This can be sensed remotely by the techniques of magnetotelluric sounding and used to delineate the approximately size and shape of the said rock volume at depth.

The wavefunctions associated with the pholes are highly delocalized, meaning that they extend over many oxygen anions in the said volume of rock subjected to deviatoric stress. This affects the bulk properties of the rocks in the said volume, even though the number density of p-holes relative to the total number of oxygen anions in the system is small, typically on the order of 100 to 1000 parts per million (ppm).

One of the bulk properties affect by the delocalization of the wavefunctions associated with the p-holes is the dielectric polarization P, meaning the response of the material to electric fields during the passage of electromagnetic waves through the said material. Depending upon the frequency of the passing electromagnetic field P determines the refractive index n (in the optical frequency range), the dielectric constant epsilon (in the far infrared and microwave frequency ranges) and the effective dielectric constant (in the frequency range lower than the microwave region). A consequence of this frequency dependence of P in the said volume of rock subjected to deviatoric stress is the dispersion of the dielectric response, viz. effective dielectric constant and alternating current (ac) conductivity, during the passage of low frequency electromagnetic waves such as employed in magnetotelluring sounding.

Another of the bulk properties affected by the delocalization of the wavefunctions associated with the pholes is the elastic constant, meaning the response of the material to the passage of sound waves composed of compressional waves and shear waves emitted by seismic events. In geophysics the compressional waves, which propagate at a high velocities on the order of 6 km/sec in the Earth's upper crust and significantly faster in the lower crust and upper mantle, are called “primary” (P), because they arrive first at a remote seismometer station, while the slower shear waves traveling at velocities on the order of 3.4 km/sec in the Earth's upper crust and fast, but never as fast as the P waves, in the lower crust and upper mantle, are called “secondary” (S), because they arrive later.

Because the delocalization of the wave functions associated with pholes in said volumes of rock at depth subjected to deviatoric stress affects the elastic properties of the said rocks, the velocities of the P waves and of the S waves are changed relative to a rock volume at the same depth range, same mineralogical composition and same texture, in which no pholes would be activated. The velocities V of the P waves and the S waves are affected to different degrees so that the ratio V_{S}/V_{P} changes. Such changes can be identified in telescismic data, using the arrival times of P and S waves from distant earthquakes as the data base from which the V_{S}/V_{P} ratio is calculated.

The observed changes in the V_{S}/V_{P} ratio of telescismic rays crossing a volume of rock at depth, where deviatoric stresses are building up, are generally explained by changes in the texture of said rocks, meaning that the morphological axes of the mineral grains are, on the average, preferentially oriented relative to the stress vector and relative to a rock with randomly oriented mineral grains. If the said changes in the V_{S}/V_{P} ratio are caused by the activation of pholes in the said rock volume, these changes will be corrected to the changes in the electrical conductivity as obtained by magnetotelluric sounding.

For the full battery currents to flow the battery circuit has to close, allowing the weakly bound electrons co-activated in the volume of rock subjected to increased levels of deviatoric stress to also flow out of said volume. For this to happen the said volume has to be in electrical contact either (i) with an electron-conductive material such as rocks at temperatures sufficiently high, approximately 600° C., to inject a sufficient number of electrons into the conduction band or into high-lying energy levels to cause a transition from the p-type conductivity of cooler rocks to the n-type conductivity of hot rocks, or (ii) with layers of brine-laden gouges along tectonic faults that provide an additional conductive pathway.

When the battery circuit closes, large, spatially distributed electric currents can flow, which will generate magnetic fields. Through coupling between the outflow current carried by p-holes and the outflow current carried by electrons, the current system can fluctuate, causing currents pulses or bursts with attendant fluctuations in the magnetic field and emission of ELF/ULF/VLF electromagnetic (EM) emissions.

### BRIEF DESCRIPTION OF THE DRAWINGS

FIG. 1A schematically illustrates an experimental setup.

FIG. 1B schematically illustrates an electrical circuit, including a rock under stress (1A), that is active according to the invention.

FIG. 2 illustrates graphically an electrical response of the experiment of FIG. 1A.

FIGS. 3A and 3B graphically illustrate O MO and AO energy levels.

FIGS. 4 and 5 illustrate graphically outflow current responses in the experiment.

FIGS. 6A-6C illustrate modeling of electrical response of a crustal block under stress, according to the invention.

FIGS. 7A-7C illustrate a division between p-type and n-type crust material at great depths.

FIGS. 8A and 8B illustrate open circuit (8A) and closed circuit (8B) conditions for a battery using the Earth as part of the circuit.

FIG. 9 graphically illustrates surface potentials and acoustic signals recorded during crack formation in a loaded granite plate.

FIGS. 10A and 10B illustrate a model of the Saguenay earthquake lights.

### DESCRIPTION OF BEST MODES OF THE INVENTION

An earthquake, when it occurs, is a chaotic event. This chaotic character is exacerbated by the heterogeneity of the Earth's crust, particularly along seismically active plate margins, which are criss-crossed by faults and pot-marked by deeply buried asperities. When and where a given fault segment will fail depends on processes that take place under kilometers of rock. Unless a history of prior seismic activity leaves a trail of signals, it is unknowable where faults go at great depths and when asperities might fail. Therefore, the tools of seismology can cast time and approximate location of the next earthquakes only in terms of statistical probability.

A simple experiment subjects igneous rocks (granite, anorthosite, gabbro) to stress and examines some associated phenomena. By connecting electrodes to the rocks, it has been demonstrated that electric currents are generated, which flow out of the stressed rock volume without externally applied voltage. These self-generated currents may hold a key to understand how powerful electric currents can be generated deep in the Earth prior to major earthquakes and what kind of signals they send out.

### Experimental

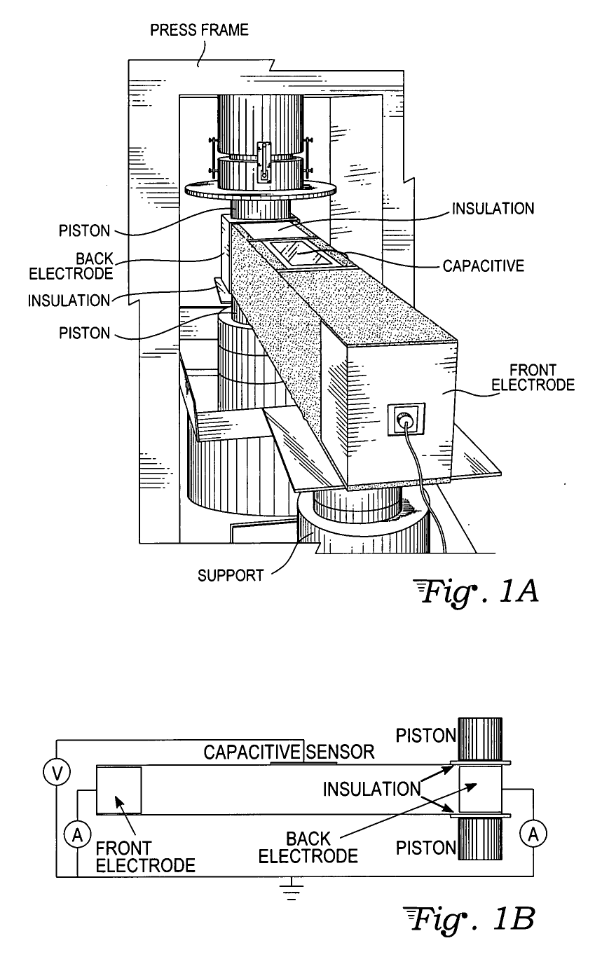

FIG. 1A shows a long granite slab, length 1.2 M with a rectangular 10×15 cm cross section, in situ, located in a press, electrically insulated from the two pistons by means of two 0.8 mm thick hard polyethylene sheets with a resistance of >10⁴ Q. The load from the press was applied uniaxially to one end of the stab between two pistons, 11.25 cm diameter, stressing a volume of about 500 cm³. The rock was fitted with two Cu tape electrodes with graphite-based, conductive adhesive, each connected to an ampere meter. One electrode surrounded the back end of the rock so that the volume to be stressed was in electrical contact with the Cu electrode and with ground. The other electrode of the same size wrapped around the front end of the rock. In addition, a non-contact capacitive sensor was placed on the top of the rock, made with the same Cu tape and 0.8 mm thick polyethylene insulator. FIG. 1B shows the corresponding electric circuit that is designed to allow stress-activated currents to flow out of the stress rock volume. The back end of the slab was loaded uniaxially at a constant rate of 6 MPa/min to a maximum stress level of 67 MPa, equal to about 1/3 the failure strength of the granite. The load was applied a total of 6 times, with 30 minute recovery intervals between loading/unloading cycles. To measure the outflow currents, two Keithley Ampere meters were used, Models 486 and 487. To measure the surface potential, a Keithyley electrometer, Model 617 was used. The data were acquired with National Instrument Lab VIEW 7.0.

The experimental was carried out with dry, light-gray, medium-grained “Sierra White” granite from Raymond, Calif., containing ca. 30 percent quartz, 30 percent microcline, 20 percent plagioclase, and 10 percent amphibole. Similar experiments, not described in detail here, were carried out with centrally loaded 30×30×0.95 cm³ rock tiles of the same granite and with other igneous quartz-free rocks such as a coarse-grained anorthosite from Larvik, Norway, and a black, fine-grained gabbro from Shanxi, China. In addition we used a white Carrara marble and plate glass for reference.

### Results and Discussion

When one end of the granite block, fitted with the two Cu electrodes, is stressed, first and second currents are immediately established out of the stressed rock volume. The currents are of same magnitude, but of opposite sign, and the associated flows are in opposite directions without any externally applied voltage. These currents increase with increasing stress. The loading/unloading cycle experiments were repeated five times, and the same two currents were observed each time.

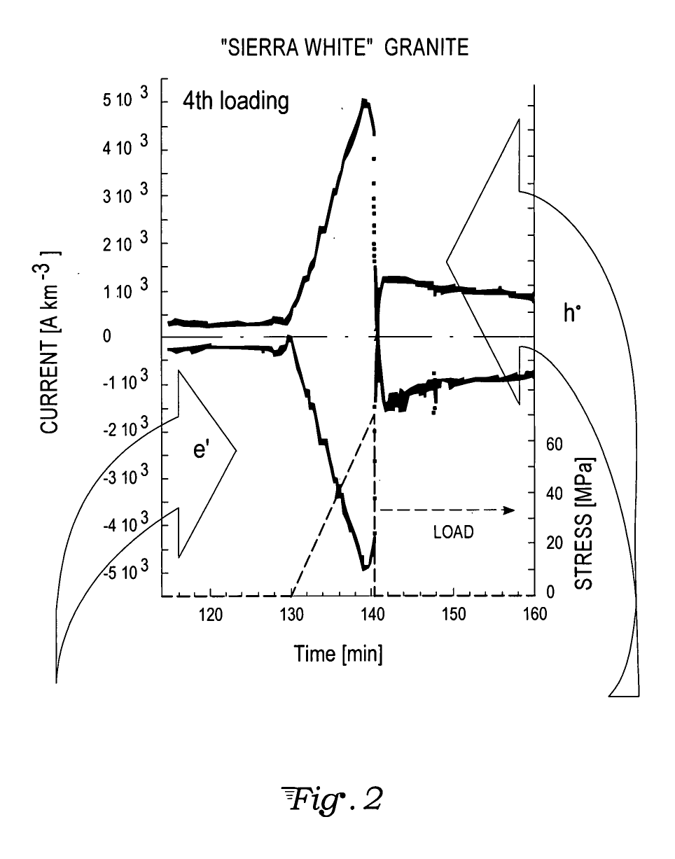

FIG. 2 summarizes the results of the fourth loading/unloading cycle. The lower trace represents the current Je carried by electrons. It flows from the stressed rock volume, the “source” (S), directly into the Cu electrode attached to the back end of the granite slab and thence to ground. The upper trace represents the current Jh carried by defect electrons, i.e. by holes. The hole current flows from the stressed rock volume (the source S) through the full length of the granite stab, through about 1 M of unstressed rock, to the front Cu electrode and thence to ground. The source volume contains 1500 cm³ of rock. Stressing 1500 cm³ to 67 MPa, about ⅓ the failure strength of the granite, leads to peak currents of about 7 nanoAmperes. Other igneous rocks such as the anorthosite and gabbro produced larger currents, by factors of 10-50.

Upon releasing the load, both currents drop precipitously but do not return to zero. Instead these currents drop to about their peak value and then decay slowly. A 30 min recovery interval at zero load between each loading/unloading cycle is not long enough to allow the currents to decay to zero. Therefore, the starting levels for the outflow currents increase with each succeeding cycle, leading to ever higher peak currents. Eventually, the peak currents reach a maximum. IN similar experiments where granite and other rocks were loaded and unloaded at constant stress rates, the outflow currents after unloading returned to near-zero and the peak currents reach always the same maximum values even after more than 20 cycles.

The outflow of the two currents implies that mechanical stress co-activates two types of electronic charge carriers, believed to be electrons and holes, presumably in equal numbers. The holes are able to flow through about 1 M of unstressed granite, while electrons are blocked form entering the unstressed portion of the rock. Instead the electrons can flow out only through the Cu electrode that is directly attached to the stressed rock volume.

This dual outflow in opposite directions implies that the boundary between the stressed and unstressed rock represents an energy barrier; this barrier allows only holes to pass and rejects electrons. This energy barrier obviously plays an important role in controlling and sustaining an observed dual current flow.

Electrons and Positive Holes

Before currents can appear, charge carriers have to be created or activated in the stressed rock volume. Because the charge carriers did not exist before, we conclude that the rock contains inactive precursors that can be “awakened” by the application of non-uniform stress.

Prior work has already brought a better understanding of the hole-type charge carriers that lie dormant in igneous rocks. These holes are defect electrons in the O⁻ sub-lattice of silicate minerals, known as “positive holes” or p-holes for short, and symbolized by PH.

A defect electron in the sub-lattice can be described as O⁻ in a matrix of O⁻ i.e., as an electronic state where the valence of oxygen has changed from 2- to 1-. In their dormant state, p-holes exist as pairs, in the form of peroxy bonds, O⁻—O⁻, or peroxy links, O₃X/^{oo}/XO₃, (X=Si, Al, etc.), which are referred to as “positive hole pairs” or “PHP.s”. These PHPs can be activated by stress and they release mobile p-hole charge carriers. However, the experiment described here demonstrates co-activation of holes and electrons. To understand this process, the PHPs and their electronic structure must be examined more closely.

As indicated by its position in the Periodic Table of the Elements, oxygen has the electronic configuration 1s²2s²p⁴, where 6 electrons to the right of the vertical bar form the valence shell. When oxygen is in its mot common 2-oxidation state, its electronic configuration becomes 1s²2s²p⁶, indicating that this oxygen has the closed-shell, 8 valence electron configuration of the noble gas neon. When oxygen is in its 1-oxidization state, its electronic configuration is 1s²12s²p⁵ with an odd number of valence electrons. Such a 7-electron configuration is unstable but can stabilize by pairing with another similar O⁻ to form a peroxy bond, O—Om with 14 valence electrons.

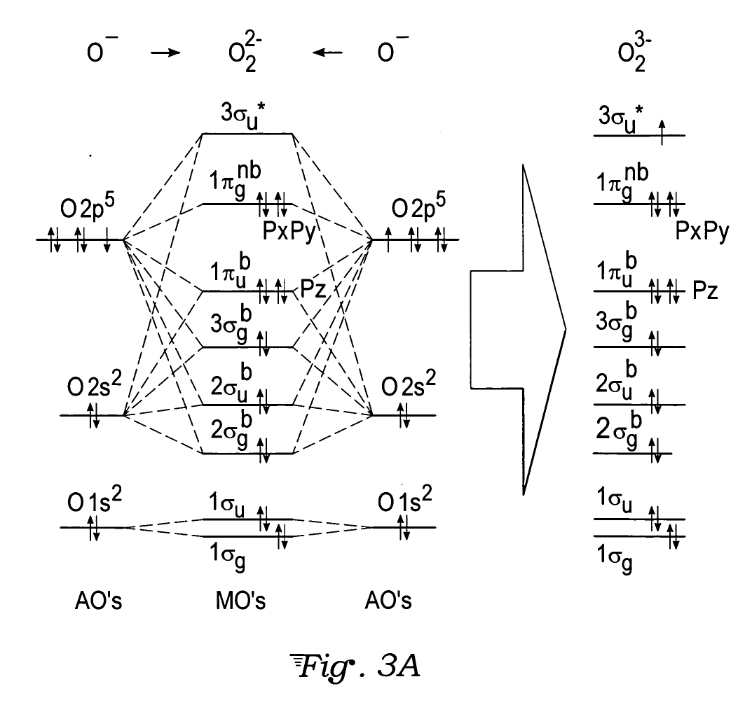

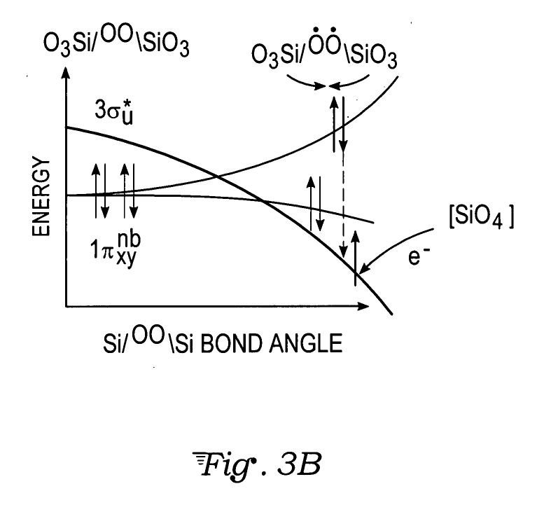

Molecular Orbitals (MO) are used to examine more closely the electronic structure of the peroxy bond. FIG. 3A illustrates graphically on the left side the MO energy levels of a peroxy entity, O₂², flanked by the energy levels of two O, each with 1s²12s²p⁵ electrons. The AOs of the two O⁻ combine to form bonding, non-bonding and anti-bonding levels. Bonds that derive primarily from the 2s and 2p_{z} AOs (z being the bond direction between the two O⁻) are called σ. In bonding σ orbitals, the electron density is between the two O⁻. In antibonding σ orbitals, the electron density is highest outside the O⁻—O⁻ bond. The MOs called represent double bonds, which derive primarily from the 2pₓ and 2p₃ AOs. The π MOs form a torus of electronic density around the O⁻—O⁻0 axis. One set is weakly bonding; the other set is non-bonding.

A hallmark of the peroxy bond is that its highest MO, the strongly anti-bonding o, is empty. Hen the peroxy bond lacks the strongly repulsive electron density of an occupied o level. As a result, the O⁻—O⁻ bond is highly covalent and the O—O bond distance (1.5 Å) is much shorter than the usual bond distance (2.8−3.0 Å) between adjacent o²—in oxide and silicate minerals.

What happens when the peroxy bond breaks? At least two reaction channels are available. One channel is followed when bulk peroxides such as BaO₂ are heated above 600° C. and decompose, BaO₂→BaO+(½)O₂. This basic step involves a regroupment of the electrons among the two O⁻0 in such a way as to split (disproportionately) their valence states, O⁻+O⁻→O⁻+O. This disproportionate reaction can take place only on the surface of solid grains and leads as its primary step to the emission of O atoms.

The other channel of more direct relevance here is open to peroxy entities embedded in the 6²-matrix of an oxide or silicate crystal. When dislocations move through a mineral grain during plastic deformation, they intersect peroxy links and briefly “wiggle” the O₃X/⁰⁰XO₃ entities, ie. change the X/⁰⁰/X bond angle. Any change in the X/⁰⁰/X bond angle leads to a decrease in the energy of the high-lying anti-bonding σ orbital and to an increase in the energy of lower-lying bonding and non-bonding π orbitals, as indicated schematically in FIG. 3B.

Every matrix-imbedded peroxy entity is surrounded by next-nearest O⁻, each with fully occupied high-lying levels that are of repulsive, anti-bonding (sp) character. When the energy of the empty σ level of the peroxy entity drops below the energy of the highest occupied (sp) levels of any of its next-nearest O⁻ neighbor, an electron from the Oz ‘cuno’aomkiooinloiboo level of the strained peroxy bond. Such electron transfer onto the peroxy entity creates a hole on the neighboring 0² i.o. turns LhioO²⁻ iotoanO⁻. Hence, one electron hopping into the peroxy bond is equivalent to one hole hopping out of the peroxy bond. This electron transfer may represent the basic step of how an imbedded peroxy entity can inject a hole into the O⁻ sub-lattice and thereby releases a p-hole charge carrier into the valence band. The spreading of the h state away from its parent peroxy entity is probably facilitated by the fact that the wave function associated with the PH is highly delocalized. By spreading over many O⁻ sites, the PH dilutes its charge density and thereby minimizes the electrostatic interaction with the parent peroxy defect, left behind with an extra electron, i.e. as a negatively charged point defect. This extra electron sits on the anti-bonding a˜orbital. On the right side of the arrow in FIG. 3A, the MO diagram is sketched from this configuration with a single, unpaired electron on the high-lying a level, although its energy is certainly different from that with an empty a orbital.

When the same rationale is applied to the peroxy link between adjacent XO₄, the energy levels split due to the lower symmetry but the principle remains the same. The extra electron is symbolized by a superscript next to the peroxy link, O₃X/⁰⁰/XO₃ and one writes:
O₃/X/⁰⁰/XO₃+O⁻→O₃X^{|00|}/XO₃+O. (1)

No calculations have been performed to date to study how the X/⁰⁰/X bond angle changes after adding an electron. It is possible, even likely, that the X/^{|00|}/X bond remains in a permanently bent form, thereby providing some degree of stability to the extra electron and preventing a rapid recombination with the hole that it has just released. At the same time there is reason to expect that the lone electrons on the a level are loosely hound and therefore represents the mobile electrons that flow out of the stressed rock volume via the Cu electrode attached to the back end on the granite block as shown in FIG. 1A. If this is correct, FIG. 3B and Eq. (1) indicate the complete reaction of interest here: (i) the generation of holes that move away from their parent peroxy entities as p-hole charge carriers and (ii) the generation of loosely bound electrons, acquired by the parent peroxy entities in the process of releasing a p-hole.

What Drives the Current Outflow?

The electric circuit shown at the bottom of FIG. 1B provides a loop needed by the electrons to allow flow from the source volume to ground and thence to the front Cu electrode. At the front Cu electrode the electrons meet the p-holes, which have traveled through 1M of granite rock. There must be some mechanism that drives this dual current outflow.

As mentioned above, only p-holes can flow through the unstressed rock, while the electrons have to take the path through the Cu electrode attached to the source volume. The inability of the electrons to flow through the unstressed rock implies a boundary between the stressed and unstressed rock that allows p-holes to pass but blocks electrons.

In the case of the granite slab the two outflow currents increase approximately linearly with the stress as shown by FIG. 2. During most of the loading the currents fluctuate synchronously, indicating that the currents are strongly coupled. However, at the beginning there is a difference.

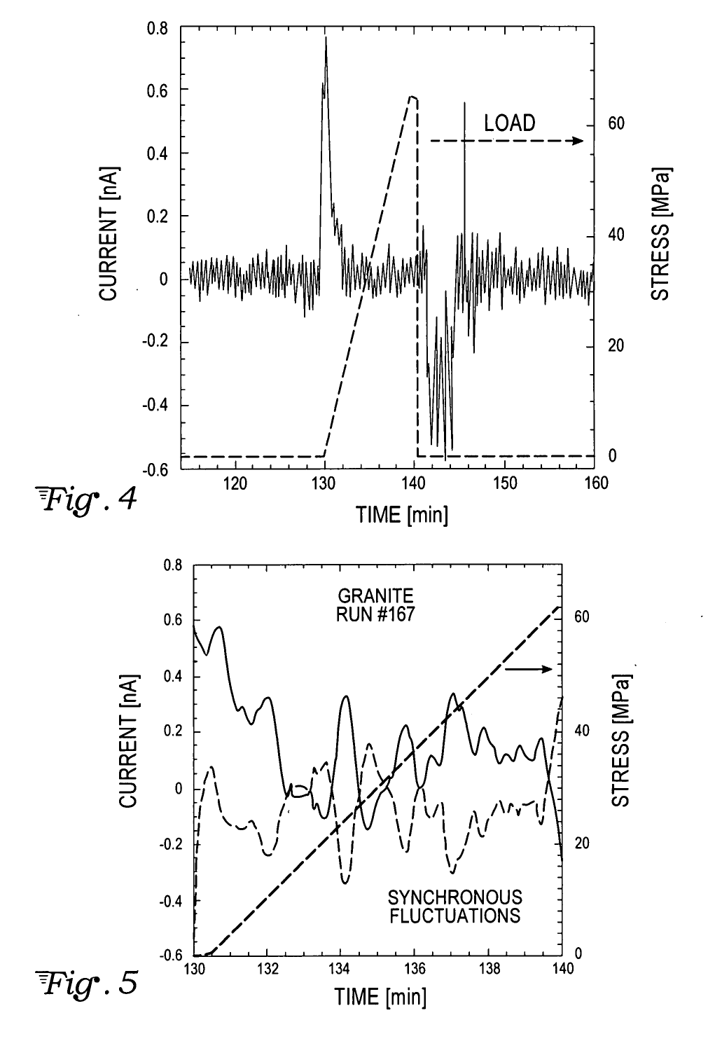

If the fluctuations were synchronous and perfectly balanced, the sum of the two currents should be zero, FIG. 4 shows that the sum of the two currents is zero except for the first 2 min, when electrons are flowing into, not out of, the source volume. This inflowing current peaks early and ends when the load has barely reached 15 MPa. After unloading a reverse current flows out of the source volume in a series of brief bursts. Integration gives 3×10¹¹ charges flowing in and about the same number, 3.5×10¹¹, flowing out of the source.

The initial inflow, about 3×10¹¹ electrons into the source volume, indicates a driving force. An indication as to what is this driving force is provided by the positive charges on the surface of the rock. In the experiment described here the surface potential reaches +25 mV. Typical values measured, when currents are drained form the rock, are +10 mV to +100 mV. Under open circuit conditions the surface potentials measured reach +1.5 to +1.75 V.

To find a reasonable explanation for the two outflow currents, the three observations presented here are combined:

i) upon loading electrons and holes are co-activated in the source volume,

ii) p-holes flow out of the stressed rock volume into the adjacent unstressed rock, and

iii) a positive charge builds up on the surface of the unstressed rock.

Step (ii), the initial outflow of p-holes, occurs in response to the concentration gradient between the source volume and the adjacent unstressed rock. When p-holes expand into a dielectric, they spread to the surface and set up the surface charge. The number of p-holes spreading out initially should be equal to the number of positive charges needed to set up a surface potential of +25 mV multiplied by the surface area, 0.5 m², of the granite slab under study here. According to some researchers, fractures or stick-slip faulting lead to surface potentials around 10 V, corresponding to charge densities on the order 10⁵ Coulomb or 6×10¹³ charges. Sealing the surface potential from 10 V to 25 mV gives about 10^{???} charges, in good agreement with the values here, given the uncertainties in measuring surface potentials and in estimating surface charge densities.

The initial outflow of p-holes pulls electrons from ground into the source volume. Thereafter, as the continuous current develops, the electron current reverses, moving out of the source volume, looping through the outer circuit to the front end of the granite slab where the electrons meet the p-holes. It is possible that this current is driven by the energy gained during recombination of p-holes and electrons at the front Cu electrode. When the load is removed, the electrons, which had initially entered the source, flow back to ground as illustrated by FIG. 4.

Coupling of the Outflow Currents

The two outflow currents always fluctuate, even at constant rates of stress increase. The amplitudes of fluctuations can reach 50 percent of the mean value. In the case of the 1.2 M length granite slab the fluctuations were less pronounced, about 10 percent or less, as shown in FIG. 5. Except for a short time interval at the beginning of loading, fluctuations are synchronous. This is also demonstrated in FIG. 4; the sum of the outflow currents is zero over most of the 10 min time window except for the first 2 min.

Synchronous fluctuations imply a strong coupling. The electric fields associated with each of the outflow currents can provide such coupling. The reason is that, when one of the currents varies, the other current reacts by increasing or decreasing in order to minimize the electric field. As a result both currents will fluctuate just as we seem to always see it in our laboratory experiments.

Modeling Pre-Earthquake Situations

The experiment with the 1.2 M length granite slab shown in FIG. 1A, and the insight gained by this new approach, can be used to build a qualitative model of the Earth's crust and of the telluric currents generated as a result of stress-activated electron and p-hole currents. The outflow currents an be scaled up from the laboratory size (source volume about 1500 cm³) to geophysically relevant stressed rock volumes. If this is done, every cubic km of granite would be able to produce 5×10³ Amps. Other rocks, in particular gabbro, produce currents equivalent to 10⁵ Amps/km³.

Synchronous fluctuations imply a strong coupling. The electric fields associated with each of the outflow currents can provide such coupling. The reason is that, when one of the currents varies, the other current reacts by increasing or decreasing in order to minimize the electric field. As a result both currents will fluctuate just as observed in the laboratory experiments.

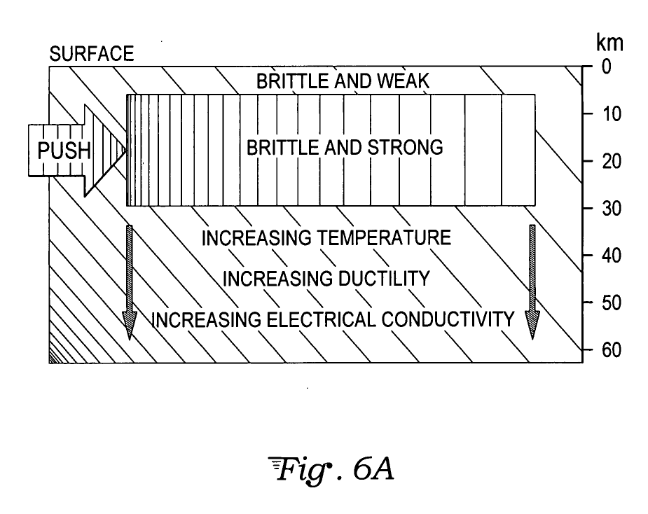

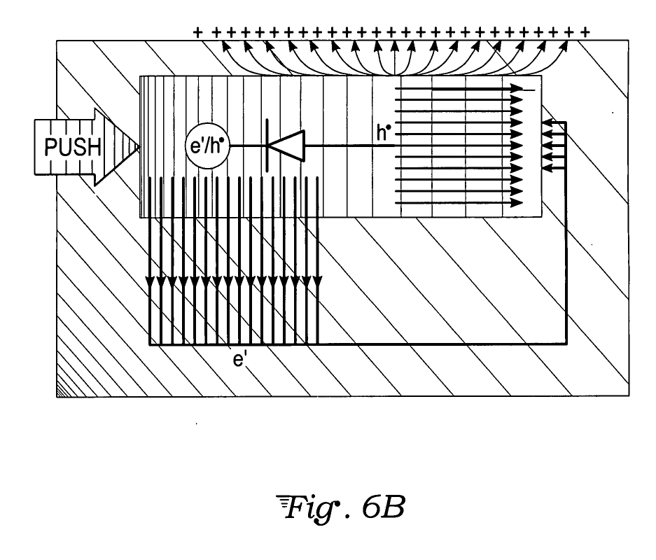

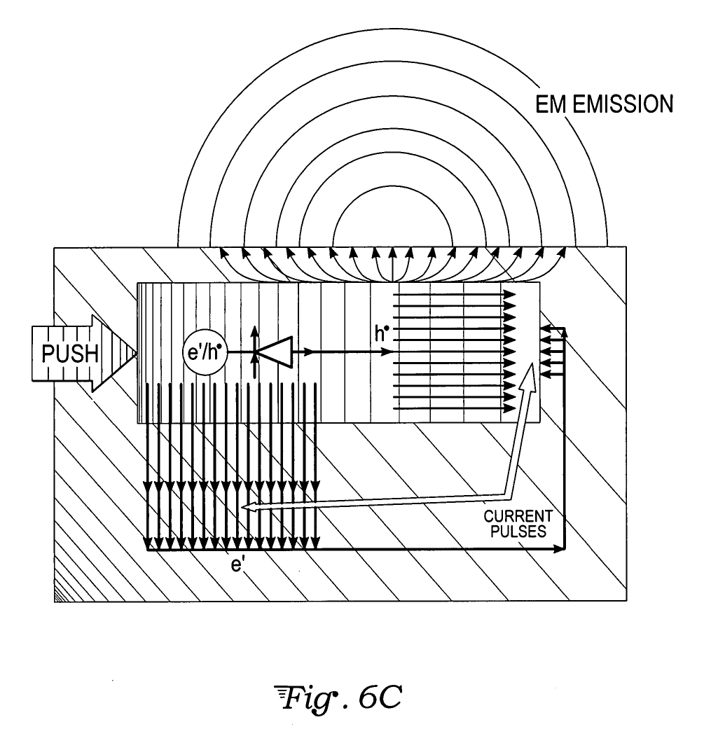

Consider a cross section through the crust featuring a 25-30 km thick block that is being pushed horizontally from the left as shown in FIG. 6A. The stress is assumed to be applied over the entire cross section from the brittle upper crust down to a depth where the rocks, due to increasing temperatures, become ductile and n-type conductive (primarily conduct electrons). By contrast, the upper portion of the crust is assumed to be p-type conductive (primarily conduct p-holes). Under ideal modeling conditions as depicted in FIG. 6B two outflow currents would develop, an electron current flowing downward into the lower crust where, due to the increased temperature, n-type conductivity prevails. At the same time a p-hole current would now horizontally in the thrust direction along the stress gradient. How the two currents reconnect is an open question. Perhaps electrolytical conductivity through the water-saturated gouge of deep faults provides a current path to close the circuit.

The same mechanism, currents flowing through gouge-filled faults, may short-circuit a large portion of the stress-activated currents. However, if the volume of stressed rocks is on the order of 10⁴ to 10 km³, as expected in situations that produce M 6.5 to M 7.5 earthquakes, and if each km³ generates up to 10³ Amps, the total amount of currents that can flow over an extended period of time, would indeed be very large. Even if 99.9 percent or more of the currents are “lost”, one might have to consider transient telluric current systems in the 10″ Amp range.

FIG. 6C introduces a model in which the electron and p-hole currents are coupled via their respective electric fields and therefore be subject to fluctuations. Such fluctuations lead to electromagnetic (EM) emissions in the low frequency range. The parameters of the transient current systems will determine the spectral characteristics of the low frequency EM emissions. The magnitude of the currents will determine the emitted power pet frequency band. Conclusions.

The model presented here is based on laboratory data, which show that rocks under stress become a source of two outflow currents of equal magnitude but opposite sign. The model represents an attempt to apply the insight gained from these laboratory experiments to geophysical situations, which are highly idealized but probably sufficiently close to reality to contain a kernel of truth.

A feature of the fluctuating telluric current concept is that is allows rationalization, in principle, as to why powerful low frequency EM emissions would become observable under certain conditions but remain unobservable in other cases. The non-observability could be due to poorly understood and poorly constrained processes in the Earth's crust that can either prevent the postulated electron and p-hole currents altogether or redirect then in ways as to cancel their EM emissions.

Given the newly discovered dual outflow currents from stressed igneous rocks and their magnitudes as inferred from our laboratory data, our model allows us to consider powerful transient telluric currents—far more powerful than could be accounted for by any of the source mechanisms discussed in the literature based on piezoelectricity, fracto-electrification, and streaming potentials.

Earthquake Lights

Earthquake-related luminous phenomena (also known as earthquake lights) may arise from (1) the stress-activation of positive hole (p-hole) charge carriers in igneous rocks and (2) the accumulation of high charge carrier concentrations at asperities in the crust where the stress rates increase very rapidly as an earthquake approaches. When a critical charge carrier concentration is reached, the p-holes form a degenerated solid state plasma that can break out of the confined rock volume and propagate as a rapidly expanding charge cloud. Upon reaching the surface the charge cloud causes dielectric breakdown at the air-rock interface, i.e., corona discharges, accompanied by the emission of light and high frequency electromagnetic radiation.

Earthquake-related luminous phenomena, also known as “earthquake lights” or “EQLs”, have been reported since ancient times, based on over 1500 reports from several various events in Japan. One researcher has noted that “The observations were so abundant and so carefully made that we can no longer feel much doubt as to the reality of the phenomena.” Nonetheless, doubts persisted in the scientific community at least until the late 1960s when EQLs were photographically documented during an earthquake swarm near Matsushiro, Japan. Yasui, a seismologist at the Kakioka Magnetic Observatory, studied reports from many people in the surrounding area, including sketches and photographs and concluded that most of the observations cannot be accounted for by atmospheric lightning, zodiacal light, auroras, meteors or by any other known sources. Similar observations were made in Mexico and in many other seismically active regions of the world.

St-Laurent has critically evaluated numerous reports of EQLs associated with the M=6.5 Saguenay earthquake in Quebec Province, Canada, on 25 Nov. 1988, which occurred during darkness, at 18:46 local time. The reports confirm the diversity of the observed luminous phenomena. One report that is particularly well supported provided insight into the processes that seem to have taken place in the Saguenay region, close to the 29 km deep hypocenter.

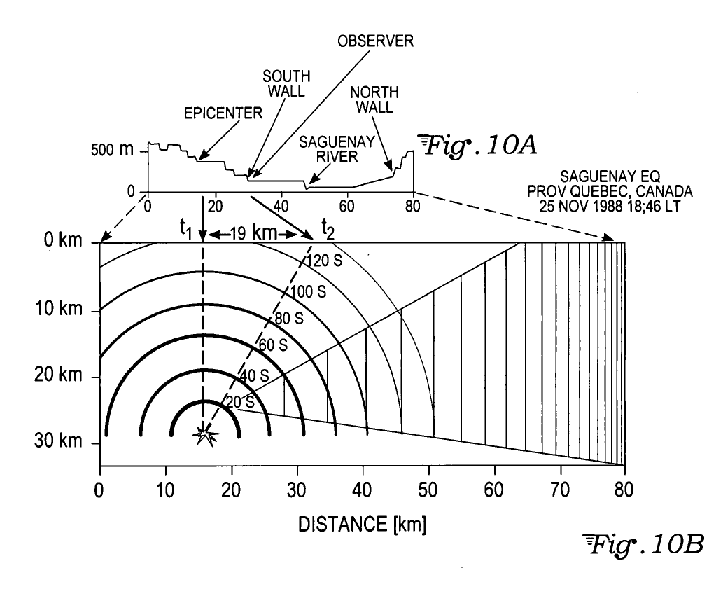

The earthquake was associated with the Saguenay graben, which runs roughly SE-NW and is nearly perpendicular to the St. Lawrence river, meeting it about 150 km northeast of Quebec city. The Saguenay graben south wall (FIGS. 10A/10B) delineates the northeastern edge of the Jacques Cartier block, a horst structure in the 600-900 M high Laurentian Plateau and exceeding it by 100-400 M.

The Saguenay earthquake was remarkable in several respects. First, it occurred outside the previously recognized seismic zones in this part of the Precambrian craton, which forms the Canadian Shield, Second, with a focal depth of 29 km it is one of the deepest inter-continental crustal earthquakes outside of plate convergence zones. Third, the high Lg-wave energy led to prolonged (2 min) and strong shaking in the epicentral region. The relatively low aftershock activity during the next six months (only 84 events, all smaller than M=3.6 except for one event at M=4.1) implies that a large fraction of the energy stored before the earthquake was released during the main shock.

There is, however, another reason for calling the Saguenay earthquake remarkable: A large number of luminous phenomena were reported from a wide area around the epicenter to the INRS, Universite du Quebec at Sainte-Foy, and to the Universite du Quebec at Chicoutimi [Quellet, 1990]. The earliest report occurs 25 days before the 25 Nov. 1988 main shock, when two individuals driving on Route 175 through the Laurentide Park observed at about 18:30 local time three luminous “masses” that rose from the ground. The area was 15 km from the nearest settlement, but close to the future epicenter. More luminous phenomena were reported during the m_{b}=4.3 (m_{b}Lg=4.8) foreshock of 23 Nov. 1988, at the time of the 25 Nov. 1988 main shock and during aftershocks. The phenomena were variously described as globular luminous masses, bands or rays or as intense atmospheric illuminations lasting from several seconds to several minutes. The phenomena were reported from places as far as 205 km from the epicenter, though the majority fell within a 50 km radius. All cases of intense atmospheric illumination were reported from within a radius of 35 km of the epicenter and most were co-seismic or nearly co-seismic with the n4→4.3 foreshock of 23 Nov. 1988.

The Ouellet compilation of 1990 contains 52 reports, of which 46 were judged to be of sufficient quality to warrant further study. Several of these reports were selected for follow-up contacts with the individuals who had made the observations and for site visits.

This discussion will focus on one particularly well-documented observation made 19 km north of the epicenter, almost co-seismic with the main shock. It was reported by Joseph A. Dallaire, a trapper who lives at Laterriere, close to the town of Chicoutimi. On 25 Nov. 1988, Dallaire returned from the nearby forest, where he had inspected his traps. The forest consisted mostly of conifers with a few birches, which had shed their leaves. The wind stood at 5 km/hour, and the air temperature hovered around 8° C. with a relative humidity of 65 percent. A few patches of a thin layer of icy snow that had been put down four days earlier remained on the ground. It was before 7 o'clock at night, about 2 hours and 45 min after sunset, about 1 hour after moonrise at phase 0.9, with mostly clear sky. Just as Dallaire emerged from the forest, looking NW in the direction of his house across an open field 700 m away, he was startled by a crackling sound approaching fast from behind him.

As soon as the crackling noise had reached Dallaire, he saw a curtain or sheet of bluish light emerging from the forest to his left and to his right. The light was hugging the ground as it moved past him, passed into the open field, and disappeared in a general North-West direction. Dallaire estimated that the sheet of light traveled the distance from the edge of the woods to his house, 700 M away, in about 2 sec. He reported that the light was bright enough to illuminate his house. As it passed his house, it exceeded the height of the house roof, 6 M, and may have been as high as 15 M. At the moment the sheet of light faded and disappeared, he felt the earthquake.

The description contains important details: (i) the event started with a bristling or crackling noise approaching from the direction of the epicenter 19 km to the left as shown in FIG. 1; the noise appears to have been caused by electric discharges off the conifer branches, indicating the buildup of a strong electric field; (ii) the curtain or sheet of light suggests an even stronger electric field that led to a discharge at the ground-to-air interface; (iii) the discharge was traveling from the direction of the epicenter; (iv) the speed of propagation was in the order of 100-300 m/sec. and (v) the electric discharge and EQL were not co-seismic but clearly preceded the seismic wave train.

Tsukuda, in 1997, reported luminous phenomena observed before and during the M=7.2, 17 Jan. 1995 Hyogo-ken (Kobe) earthquake, which occurred in early morning darkness at 5:46 local time. The light spread rapidly to several kilometers in width and was estimated to reach up to 200 m in height with intensities estimated at 10 candela/M-: “According to most eyewitnesses the luminosity started from ground level on land, suggesting that discharge processes . . . in near-surface rocks may be the primary driving force”.

While there are many observations from many independent sources, some uncertainty remains about the physics that underlies the emission of light from the Earth's surface before or during major earthquakes or during aftershocks. Most efforts to provide a physical explanation of the phenomenon centered on piezoelectricity, a property of quartz to generate electric fields on opposite sides of a single crystal when stressed in certain crystallographic directions. However, when a rock containing quartz is stressed, the electric fields generated by a large number of individual crystals cancel and the resulting field becomes zero. This is true for random orientations of the quartz crystals, as well as for preferentially aligned quartz crystals. Other processes like tribo- or fracture electrification or exo-electron emission seem inadequate to produce the large electric fields needed on large scales to account for at least the more powerful and sustained EQLs that have been reported.

Dormant Charge Carriers in Rocks

Igneous rocks contain charge carriers, the very existence of which has been overlooked in the past. These charge carriers are electronic in nature and seem to be ubiquitous in igneous rocks. Most importantly in the context of EQLs they can be activated by stress.

FIG. 2 shows schematically what happens when one loads one end of a 1.2 M length granite slab fitted with Cu electrodes at both ends. Two types of charge carriers appear inside the stressed rock volume on the left: holes and electrons. As indicated by the arrow inside the rock the holes flow from left to right through the rock. Instead they flow from the source S into the Cu electrode on the left and thence to ground. The electric circuit closes by the electrons flowing through the external wire as indicated by the thin arrow and meeting the holes at the right-hand end of the granite slab.

The outflow of two currents from the stressed rock volume in opposite directions indicates that the boundary between stressed and unstressed rock acts as a diode. The diode lets the holes pass but blocks the electrons. Note that the two currents flow without externally applied voltage. They are self-generated. The driving force is provided by the stress gradient. As the holes flow out from the stressed rock volume into the unstressed rock, they set up an electric field. This electric field pulls the electrons out of the stressed rock volume and causes them to flow through the external circuit to meet the holes at the right end of the slab. This electric field tightly couples the two currents and forces them to synchronize.

The holes are defect electrons in the O 2p-dominated valence band of the silicate minerals, i.e. that consist of electronic states that can best be described as a change of the valence of oxygen anions from their usual 2-state to the 1-state. They are equivalent to O⁻ in an O⁻ matrix. These are referred to as “positive holes” or p-holes for short, symbolized by HP. The presence of these charge carriers in (otherwise insulating) oxide and silicate materials has been established through studies involving single crystals and rocks. Normally the p-holes are inactive, i.e. dormant in the form of positive hole pairs, PFLPs, chemically equivalent to peroxy links of the type O₃Si—OO—SiO₃. When rocks are placed under stress, mineral gains begin to plastically deform. This deformation causes dislocations to move and new dislocations to be generated. The moving dislocations intersect the peroxy links and cause them to momentarily break. The higher the rate of deformation, the more dislocations appear and the more p-holes are activated per unit rock volume. We can represent this generation process as a two-step process:
0₃Si—OO—SiO₃→O₃Si—0′.O—SiO₃→|O₃Si—00—SiO₃I+HP

PHP broken PHP loosely bound electron mobile p-hole where the dots • signify O′ states of the broken peroxy link, the superscript an electron that has moved in, and HP a p-hole that has moved out.

The electrons that are co-activated alongside with the p-holes are loosely hound and thus mobile. A stressed rock volume becomes a “source” which can release both p-holes and electrons.

The p-holes have the unusual property that, being electronic states in the valence band, they are able to spread out of the source into the surrounding unstressed rock. To travel, the p-holes use the O 2-p-dominated upper edge of the valence band, which provides for a small but finite p-type conductivity. The p-holes can therefore propagate through unstressed rock and even cross different rock types.

The electrons are unable to flow from the stressed rock into the unstressed rock because they need an n-type conducting pathway. In the experiment sketched in FIG. 2, this n-type connectivity was provided by applying one of the Cu electrodes directly to the source volume. In nature, in the Earth's crust, n-type conductivity becomes available at high temperatures (T≧600° C.), viz. at greater depths along the geotherm.

Geophysical Scenario

FIG. 6B translates the geometry of the laboratory experiment shown in FIG. 2 into a geophysical scenario, presenting a cross section through the crust down to the hot mid- to lower crust. It is assumed that the crust is to be pushed by tectonic forces from the left to the right causing p-holes and electrons to be activated. It is further assumed that p-holes can flow out horizontally through the p-type conductive cool upper portions of the crust, while electrons connect downward to the n-type conductive, hot mid- to lower crust. However, there may be situations where the outflow currents do not keep up with the production rate of p-holes and electrons in the stressed volume.

This situation can arise when the concentration of charge carriers increases very rapidly due to rapid stress increase. At some point the charge carrier concentration reaches a point at which the charges form a degenerate charge cloud. Such a state can become unstable and break out of its confined volume as a solid state plasma propagating outward explosively as a p-hole cloud. When the plasma crosses the surface, it causes ionization of the air, corona discharge and light emission.

Electrical Discharges in Laboratory Experiments

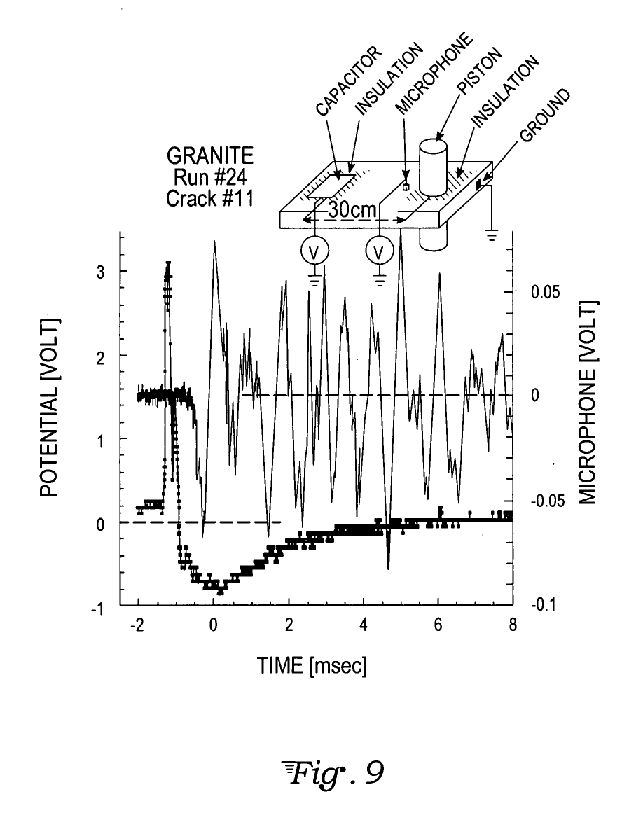

Laboratory observations have been reported that suggest some kind of solid state plasma formed in highly stressed rock volumes by p-hole charge carriers and their burst-like expansion, though these observations had not analyzed in this physical context. An example is shown in FIG. 11A???. A granite plate, approximately 30×20×2 cm³, was loaded on an inner portion (not at one end) at a constant stress rate up to failure. During loading but before failure several cracks formed inside the stressed rock volume. Acoustic signals were recorded with a microphone placed about 5 cm from the edge of the piston. In addition, as sketched in the inset in FIG. 9 a capacitive sensor was installed about 20 cm from the edge of the piston to record the surface potential.

Over a several-minute time interval, several cracks spread before failure of the rock triggered the data acquisition system. During each crack, a burst of positive voltage was recorded at the location of the capacitive sensor, lasting less than 50 μsec and followed by a longer lasting negative voltage. However, as shown in FIG. 9 for a crack, the burst-like positive signal arrived about 1 msec before the microphone recorded the acoustic signal of the crack itself. The amplitude of the voltage burst, +3 V but occasionally up to +12 V, was significantly higher than the steady state surface potentials, which were less than +100 mV, observed during loading. Other researchers observed similar positive voltage signals during strike-slip faulting experiments and have reported pulses up to +17 V. The positive sign, high amplitude and shortness of the voltage signal are all consistent with a p-hole charge cloud that expanded rapidly from inside the severely stressed rock volume, presumably from the micro-volume which was about to crack. From this it can be inferred that the rate of generation of the charge carriers in the stressed rock volume reaches its maximum shortly before fracture.

The timing of the positive voltage burst relative to the fracture event can be further examined. From impact experiments it is known that p-hole charge clouds propagate at speeds between 100-300 m/sec, which are consistent with the concept of p-holes propagating via electrons hopping in the opposite directions from O⁻ to O⁻ sites at the frequency of the lattice phonons. The jump distance is on the order of 3 Å (3×10⁻¹⁰ M), and the phonon frequency is on the order of 10¹² sec⁻¹. Hence, 3×10⁻¹⁰×10¹²=300 M/sec. Acoustic signals propagate through granite at 6 km/sec for compressional (P) waves and at 3.4 km/sec for transverse (S) waves. Hence, the acoustic signal of the crack event would reach the microphone in about 10 μsec, while the voltage pulse takes 100 times longer, about 1 msec, to reach the capacitive sensor at the location shown in FIG. 9. Since the voltage pulse arrived 1 msec before the acoustic signal, it must have been generated at its starting point, in the aforementioned micro-volume, 2 msec before the crack.

During the experiment illustrated in FIG. 9, the light emission or the emission of kHz electromagnetic (EM) radiation, characteristic of electric discharges, were not simultaneously measured. However, the shape of the positive voltage burst and its subsequent broader negative voltage are very similar to the voltage pulses recorded during low-speed (100 M/sec) impact experiments. In these experiments a positive charge cloud was generated by the sudden stress to rock volume around the impact point. The charge cloud spread through the rock samples and arrived at the surface, causing the voltage signal to increase. The increase of the positive surface potential was interrupted above 400 mV by a sudden emission of light, which came from the sharp edges of the rock where the electric field is highest. At the same time, a burst of 10-20 kHz EM radiation was recorded. Light emission and a burst of radiofrequency radiation are both clear indicators of a luminous corona discharge.

Taking these various observations into account, it appears that the +3 V voltage burst recorded about 1 msec before cracking and shown in FIG. 9 must have been accompanied by a corona discharge due to the high electric field that built up at the rock surface upon arrival of the p-hole charge cloud. Hence, the experiment shown in FIG. 9 must have produced a small, artificial EQL.

Saguenay Earthquake Light Observations

Now return to the field observations, specifically to the reports on EQLs associated with the Saguenay earthquake. The wide distribution of reported EQL sightings during the time leading up to the Saguenay event and the fact that the earliest report came 25 days before the main shock indicates that the entire region was building up stress to a critical level. Interesting faults, buried plutons, rift pillow and other deep structures are capable of localizing stresses and of acting as “stress concentrators”. According to Du Berger et al. (1991) “plutons in the region span an area of few hundred square kilometers and extend to middle and lower crustal depths and are mostly composed of granite, mangerite, mafic dikes and gabbro”. Small volumes within this crystalline basement presumably became critical in the sense that, by accumulating localized stresses, these small volumes produced p-hole concentrations high enough to initiate an outburst of a charge cloud. The outbursts led to electric discharges at the Earth's surface but were not necessarily accompanied by foreshocks. In some ways, these local stress concentrators behaved similar to the micro-volumes in our rock deformation experiment depicted in FIG. 4a. These micro-volumes became critical one after the other and cracked, while the overall stress increased. In the Saguenay event, each of the local stress concentrators released stresses at great depth or transferred them laterally onto the remaining asperity, which eventually broke catastrophically during the main shock.

FIG. 10A shows a vertically exaggerated cross section of the Saguenay graben, −40 km wide. Indicated from right to left are the North Wall, the Saguenay River, the location of the observer (J. A. Dallaire), the South Wall, and the epicenter. The Saguenay earthquake was initiated at a depth of 29 km near the south rim of the Graben [Roy, et al., 1993]. FIG. 10B shows a section through the crust with the hypocenter marked by a star where t, and t₂ are, respectively the epicenter and the location of the observer J. A. Dallaire at a distance of 19 km. The hypocenter is shown as a source of a charge cloud expanding at −300 M/sec.

It is assumed that the hypocenter was the last asperity where the stresses accumulated and reached their highest values shortly before the main rupture. The volume of this asperity can be considered analogous to the micro-volume in the stressed laboratory rock sample shortly before a crack forms. As in the case of the laboratory experiment, when stresses build up, dislocations are generated in increasing numbers on the scale of the individual mineral grains, thereby activating an ever larger number of p-holes and electrons. Assuming a constant rate of deformation, the stresses increase very rapidly as the system moves closer to catastrophic failure. The consequences will be that the rate at which p-holes and electrons are generated will eventually exceed the rate at which the charge carriers can be dissipated. It is therefore conceivable that, shortly before rupture, a cloud of charge carriers, presumably p-holes, will burst out of the confined volume of the asperity and expand outward as depicted in FIG. 10B. On intersecting the surface above, this massive charge cloud will induce a large electric discharge at the air-rock interface and a luminous corona discharge similar to the corona discharges produced during the impact experiments.

Assuming a speed of propagation of the charge cloud in the range of 100-300 M/sec and recalling from Dallaire's report that the rapidly moving curtain of light arrived at his location before the first seismic wave train, one can estimate the time at which this outburst must have started at the asperity which we identify with the hypocenter. The distance from the hypocenter to Dallaire's location is about 36 km. The Y waves takeabout 6 sec to travel this far at 6 km/sec. A p-hole charge cloud travelling at 300 m/sec would cover the same distance in 120 sec. Hence, in order to arrive at Dallaire's location before the fastest seismic wave train, the charge cloud must have burst out of its confinement near the hypocenter 130 sec before the rupture. This implies that the maximum of the charge carrier generation process in the source volume was reached about 130 sec before rupture. The estimated 2 sec which the light curtain needed to traverse the 700 M wide open field in Dallaire's situation agrees with a speed of p-hole propagation on the order of 300 M/sec. The relatively low speed of propagation of the charge cloud is echoed in many other reports that the luminous flashes associated with earthquakes are short-lived but longer-lasting than lightning strikes.

### Conclusions

On the basis of the foregoing discussion it appears that the luminous phenomena associated with earthquakes, often called earthquake lights or EQL, are caused by electric discharges. The source of these discharges lies in the Earth's crust, in confined rock volumes that represent asperities and build up high and rapidly increasing stresses as part of the earthquakes preparation process. Such stress activate electronic charge carriers that lie dormant in the rocks. These charge carriers are p-holes and electrons, of which the p-holes have the unique property that they can propagate through otherwise insulating rocks.

If the rocks at which the p-holes and electrons are activated exceeds the rate at which they can be dissipated, a situation may arise where the p-holes form a degenerate solid state plasma that can burst out of its confined rock volume and propagate at relatively high speed through the overlying rocks. When this charge cloud intersects the Earth's surface, it causes ionization of the air and, hence, corona discharges, which are accompanied by the emission of light. The many different forms and shapes of EQLs that have been reported suggest that the conditions of the solid state plasma and its discharge through the Earth's surface can be highly variable.

These conclusions appear consistent with not only the observed luminous phenomena but also with the reported emission of radio-frequency electromagnetic radiation and other effect.

### SUMMARY OF EFFECTS

1. Basic Processes

The processes, on which an “Earthquake Early Warning System” is founded begins with the activation of mobile electronic charge carriers in rocks due to deviatoric stresses imparted onto the rocks by tectonic forces. Before the application of stress(es), the charge carriers exist in the constituent minerals of magmatic and high grade metamorphic rocks in the form of dormant, electrically inactive point defects. These defects are characterized by two oxygen anions in the valence state 1, forming a peroxy bond.

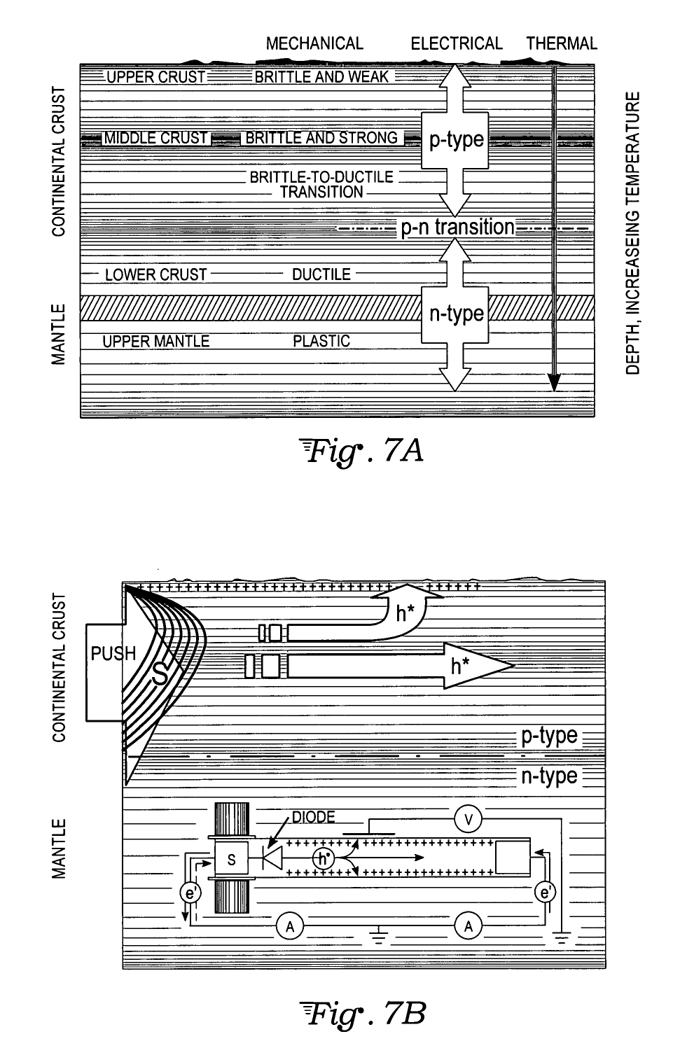

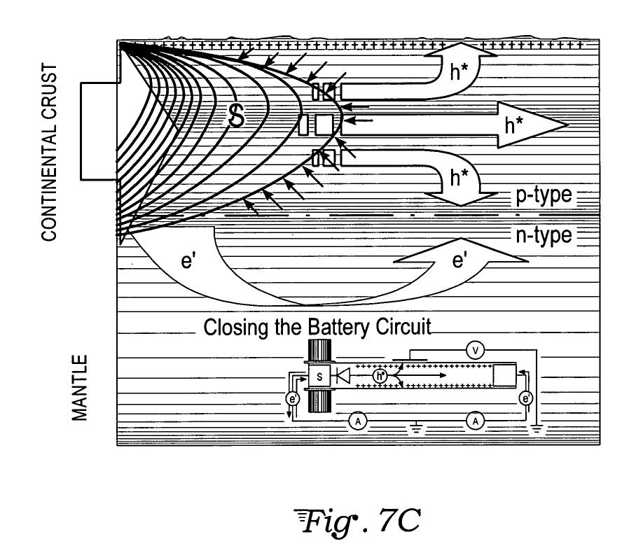

Deviatoric stresses generate dislocations, which move through the mineral grains, interacting with the peroxy defects and causing them to momentarily dissociate. In this process, each dissociated peroxy defect generates a weakly bound electron, which remains associated with the now-broken peroxy bond, and a defect electron or hole (p-hole). Ideally, there will be an equal number of electrons and p-holes inside the stressed rock volume. Because of the higher mobility of electons, the stressed rock volume will be n-type conductive, as indicated in FIGS. 7A, 7B and 7C.

1.1. P-holes

A p-hole is an electronic state associated with O⁻ in a matrix primarily composed of O⁻, hence a defect electron. P-holes can spread from a stressed rock volume into a surrounding unstressed or less stressed rocks. The boundary between stressed and unstressed rocks acts as a barrier, as in a diode, that allows p-holes to pass but rejects electrons. Therefore, the n-type stressed rock volume is bounded by the surrounding unstressed rocks by an n-p junction.

The p-holes can propagate through unstressed rocks, which have a small but finite conductivity for p-holes so that unstressed rocks are generally characterized as being weak p-type semiconductors.

In order to produce enough p-holes to flow out of a given stressed rock volume, the rate at which the deviatoric stresses are applied to generate electrons and p-holes must be higher than the rate at which the electrons and p-holes recombine or are otherwise lost from the pool of activated electronic charge carriers.

1.2. Battery

This situation is analogous to a battery. The stressed rock volume represents the “battery” (electrochemical component) that becomes charged through the application of deviatoric stresses). In this model, two types of charge carriers are activated, electrons and p-holes. P-holes can flow out into the surrounding unstressed rocks, while electrons must wait until contact is established with an(other) n-type material. Until this contact is established, the electric circuit for electrons is open. The “battery” may charge further with increasing stress or stress rate. P-holes may move out from the stressed rock volume, even under open circuit conditions, charging the surrounding unstressed rocks positive relative to a global reference potential.

This is essentially an electrostatic charging process. The amount of current that moves is relatively small. No large, sustained currents are possible as long as the electric circuit is not closed, meaning that a conductive pathway needs to be established to allow the electrons to also flow out of the stressed rock volume. Circuit closure can be achieved via contact with an n-type material that would allow electrons to flow out and recombine with the p-holes that have traveled through the p-type conductive upper layers of the crust.

1.3. Valence Band

Traveling along the valence band of weakly p-type conducting silicate minerals, p-holes can cross boundaries between different grains and different types of rocks. They can propagate through igneous and high-grade metamorphic rocks, most sedimentary rocks, even loosely consolidated sediments, gravel, sand and soil.

Even without closure of the electric circuit, p-holes can move out from the stressed rock volume into the surrounding unstressed rocks. They can spread laterally in the Earth's crust, upward to the Earth's surface, and downward toward the increasingly hot interior of the Earth.

1.4. Conduction Band

The increase in temperature along a geotherm leads to a boundary, below which rocks are sufficiently hot to change from p-type to n-type conductivity so that these (hotter) rocks become electron conductors. Therefore, the Earth's crust can be divided into two regions: an upper cooler layer, which is primarily p-type, and a deeper hotter layer, which become n-type. With increasing temperature, electrons are more and more injected into the conduction band or high-lying conduction levels. Because of the high mobility of electrons relative to holes and p-holes, small concentrations of electrons on these higher level suffice to cause a p-to-n transition. The Earth's crust can be characterized by a horizontally extending p-n junction located at a certain depth, probably along a isotherm around T=600° C. This places this p-n junction at a depth of 30-35 km, although this depth is not critical.

2. Link to Pre-Earthquake Situations

One can use the concepts developed in the preceding to construct a model of the Earth's crust, subjected to a tectonic force acting in a generally horizontal direction over the entire cross section of the crust. The tectonic force is assumed to push the crust at a constant speed (constant strain). Confined rocks at great depths will experience a non-linear increase in stress. The stress will rise non-linearly, eventually reaching a point where it increases beyond a threshold value.

2.1. Processes Under Circuit Conditions

Several processes will occur in the Earth's crust under open circuit conditions.

2.1.1. Effects on the Ionosphere

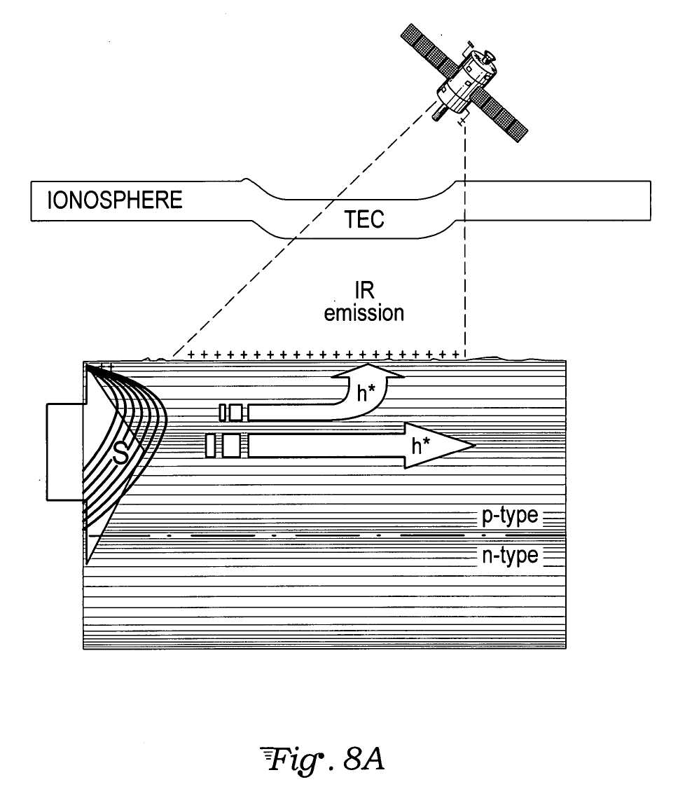

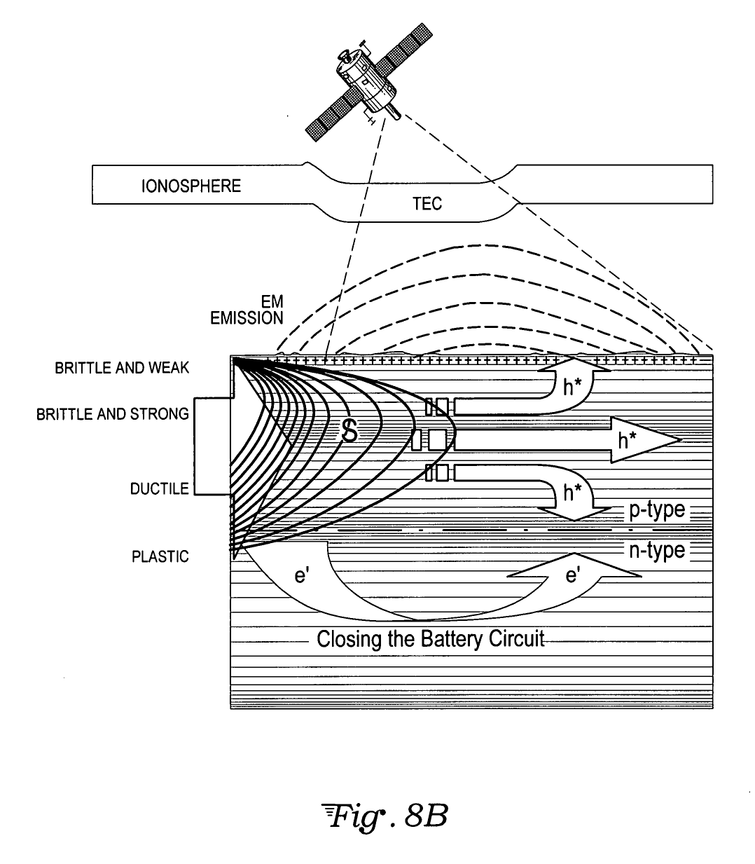

As the positive charge increases on the Earth's surface, due to an influx of p-holes from below, the regional ground potential will become abnormally positive. One of the consequences, as sketched in FIGS. 8A/8B is a reflection of the ground charge in the ionosphere, allowing energetic electrons to penetrate deeper into the lower ionosphere and increasing the Total Electron Content (TEC) of the ionosphere. Oxygen atoms in the rarefied uppermost atmosphere would be more intensely excited, giving rise to a red luminescence at a wavelength 630 nm.

2.1.2. Ionization of the Near-Surface Air

The positive surface charge formed by an influx of p-holes appears to give rise to microscopically very large electric fields, sufficiently large to give rise to field ionization of air molecules and various forms of electric discharges into the air. One of the consequences is the formation of airborne positive ions, known to have a number of physiological effects on humans and animals. Another consequence is a pervasive emission of radio-frequency noise.

2.1.3. Stimulated Infrared Emission

Within the surface charge layer, the p-holes will have an increased probability to recombine, reforming peroxy bonds. This is an exothermal process, which will lead to vibrationally highly excited O—O bonds (estimated vibrational temperature>10,000° K.). The excess energy of these excited states will be radiated away in the form of mid-infrared photons giving rise to a series of narrow emission bands due to the radiative de-excitation of the O—O bonds in the wavelength region longer than 10.5-10.7 μm. As suggested by FIG. 8A, this diagnostically distinct infrared emission feature appears to be the physical cause of the reported pre-earthquake “Thermal Anomalies” identified in night-time infrared satellite images.

2.1.4. Chemical Effects

The build-up of charges due to the influx of p-holes from below can also lead to changes in the ground water and well water composition due to electrochemical reactions leading to changes in pH and/or cation composition.

2.1.5. Changes in the Electrical Conductivity Structure of the Crust

Because the application of stress activates peroxy defects and generates both electron and p-holes in the “source” volume, the density of electronic charge carriers in this volume will increase. This leads to an increase in the electrical conductivity of the rocks as monitored by telluromagnetic (TM) techniques.

2.1.6. Changes in the Seismic Wave Velocities

Based on theoretical considerations and confirmed by preliminary experimental data, the wave functions associated with the p-holes are highly delocalized, thereby affecting many bulk physical parameters of the rocks in which these electronic charge carriers are activated by deviatoric stress(es). Among these physical parameters are the seismic P-waves and S-waves giving rise to changes in the V_{P}/V_{S} ratios.

2.2. Processes Under Closed Circuit Conditions

Several processes will occur in the Earth's crust under closed circuit conditions.

2.2.1. Low Frequency Electromagnetic Emissions

When a battery circuit closes at great depths, powerful electric currents are expected to move through the closed circuit. If these currents fluctuate, they would give rise to strong low frequency electromagnetic emissions that can be detected by antenna stations on the ground, near-by and far, and/or by satellites as depicted in FIG. 8B.

2.2.1. Magnetic Field Anomalies

Slowly varying electric currents in the ground will give rise to changes in the local or regional magnetic fields recorded by geomagnetic stations and/or by satellites as shown in FIG. 8B.

What is claimed is:

1. A method for producing an electric current having a current value in a selected range between a first partial volume A and a second partial volume B of a solid material, the method comprising:
providing a rock or similar material (“stone”), drawn form a selected group of materials;
applying a deviatoric stress in a region to the partial volume A of the stone, to produce a non-uniform stress field in which the stress has a substantially different magnitude in a first partial volume A of the stone than the magnitude of the stress in the second partial volume B of the stone; and
receiving an electric current, having a non-zero current value within a selected current value range, moving between the first partial volume A and the second partial volume B.

2. The method of claim 1, further comprising choosing said rock to have an igneous rock component.

3. The method of claim 1, further comprising choosing a material for said stone to include peroxy defects as a component of said stone.

4. The method of claim 1, further comprising choosing said stone to be an oxide material.

5. The method of claim 1, further comprising providing said applied deviatoric stress at a substantially constant stress value.

6. The method of claim 1, further comprising providing said applied deviatoric stress with a monotonically increasing stress value.

7. The method of claim 1, further comprising providing said applied deviatoric stress with a monotonically decreasing stress value.

8. The method of claim 1, further comprising choosing said applied deviatoric stress from a group of stresses, applied only in said first partial volume A, not including said second partial volume B, and consisting of: compressive stress in a plane substantially transverse to a selected axis; tension stress in a direction substantially transverse to a selected axis; tension stress in a direction substantially parallel to a selected axis; shear stress in a plane substantially transverse to a selected axis; and shear stress in a plane having a plane component substantially parallel to a selected axis.

9. The method of claim 1, further comprising choosing said first partial volume A to be adjacent to an end of said stone.

10. The method of claim 1, further comprising choosing said first partial volume A to lie in an interior region of said stone, not adjacent to a first end or to a second end of said stone along a selected axis of said stone.

11. A method for predicting occurrence of an earthquake in a selected region of the Earth, the method comprising:
providing a computer that is programmed to perform at least one of the following determinations (1)-(10):
(1) to determine if a fluctuating magnetic field in the selected region, having a maximum magnitude field intensity greater than a selected magnetic field intensity threshold value, is present;
(2) to determine if p-hole concentration on and adjacent to the Earth's surface in at least a part of the selected region that is greater than a selected p-hole threshold value, is present;
(3) to determine if electron concentration in at least a portion of the ionosphere adjacent to the selected region that is greater than a selected electron threshold value, is present;
(4) to determine if an increase in electrical conductivity of rocks located adjacent to the Earth's surface in the selected region having a value that is greater than a selected electrical conductivity threshold value, is present;
(5) to determine if an increase of low frequency electromagnetic emissions, in a frequency range ______ kHz, adjacent to the Earth's surface in the selected region, that is greater than a selected EM emission threshold value, is present;
(6) to determine if a wavelength component in a range of approximately 630 nm, that is greater than a selected wavelength fraction threshold value, is present;
(7) to determine if airborne positive ions adjacent to the Earth's surface in the selected region having an ion density greater than a selected ion threshold value, are present;
(8) to determine if radio frequency noise adjacent to the Earth's surface in the selected region having a noise value above a long term ambient noise value greater than a selected noise difference threshold value, is present;
(9) to determine if a change in at least one of water pH and cation composition of at least one of well water and ground water that is greater than a selected water composition threshold value, is present; and
(10) to determine if a change in at least one of seismic P-wave velocity and seismic S-wave velocity in at least one rock located adjacent to the Earth's surface in the selected region, that is greater than a selected seismic velocity change threshold value, is present; and
(11) where at least one of the determination in (1)-(10) is answered affirmatively, to interpret this condition as indicating that an earthquake will soon occur in the selected region.
